(19) United States
(12) Patent Application Publication
(10) Pub. No.: US 2021/0189639 A1
(43) Pub. Date: Jun. 24, 2021

(54) UV PATCH

(71) Applicant: JBW Fiber Fix Holdings, LLC, Marietla, GA (US)

(72) Inventors: Reed Quinn, Orem, UT (US); Chris Quinn, Orem, UT (US)

(21) Appl. No.: 17/191,575

(22) Filed: Mar. 3, 2021

Related U.S. Application Data
(63) Continuation of application No. 16/541,923, filed on Aug. 15, 2019, now abandoned.
Application No. 16/541,923 is a continuation of application No. 14/738,127, filed on Jun. 12, 2015, now abandoned.

(51) Int. Cl. D06M 15/564; D06M 15/55; D06M 11/79; B29C 73/10; D04H 1/587; C09J 7/21; C09J 7/30

(52) U.S. Cl. CPC D06M 15/564; D06M 15/55; D06M 11/79; B29C 73/10; D04H 1/587; B29C 2035/0827; C09J 7/30; C09J 2433/00; C09J 2400/263; C09J 2400/143; C09J 7/21

(57) ABSTRACT

A UV patch for repairing inanimate objects. The UV patch includes a fibrous material. The UV patch also includes a UV activated hardening material. The UV activated hardening material is impregnated within the fibrous material and hardens when exposed to UV radiation.

### CROSS-REFERENCE TO RELATED APPLICATIONS

This application is a continuation of U.S. patent application Ser. No. 16/541,923, filed on Aug. 15, 2019, which is a continuation of U.S. patent application Ser. No. 14/738,127, filed on Jun. 12, 2015, the entire disclosure of which is incorporated by reference herein.

### BACKGROUND OF THE INVENTION

When faced with the problem of a broken or weakened inanimate object, such as a hole in a metal container, a user generally has the choice of attempting to repair the item using conventional methods or replacement parts, or discarding the item and purchasing a replacement. Neither approach is particularly satisfactory.

For example, if the user should choose to replace the item, the user will incur the expense of the item and possibly other expenses, such as shipping and taxes. In terms of intangibles, the user must spend time to locate and purchase the item, when that time might be profitably employed in other pursuits. In other instances, where the item may be relatively uncommon, it may be difficult or impossible to find a suitable replacement. In such an instance, the user may have to strike a compromise and attempt to find a substitute that may or may not be fully satisfactory for its intended use.

Rather than attempting to find a replacement for the broken item, the user may attempt to repair the item, and thereby avoid some of the difficulties noted above. However, depending upon the item to be repaired and the type of damage, some breaks or other damage may not lend themselves to a wide range of remedies. Thus, a user may attempt to affect a repair of a broken item with materials such as duct tape or electrician's tape; however, such materials can deteriorate relatively quickly due to exposure to conditions such as moisture, sunlight, and abrasion. Moreover, where repair of a rigid item, such as a bathtub or sheet of metal for example, is desired, flexible materials such as the aforementioned tapes may not provide for a particularly effective repair.

Accordingly, there is a need in the art for a repair material that can allow a user to repair rather than replace an item. In addition, there is a need in the art for a repair material that can provide a rigid structure during the repair. Moreover, there is a need in the art for a repair material which adheres directly to the object in need of repair.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a UV patch for repairing inanimate objects. The UV patch includes a fibrous material. The UV patch also includes a UV activated hardening material. The UV activated hardening material is impregnated within the fibrous material and hardens when exposed to UV radiation.

Another example embodiment includes a UV patch for repairing inanimate objects. The UV patch includes a fiberglass felt. The UV patch also includes a UV activated hardening material. The UV activated hardening material is impregnated within the fiberglass felt in an inactivated state and hardens when exposed to UV radiation. The UV patch further includes a backing material disposed proximate to the fiberglass felt.

Another example embodiment includes a repair kit for repairing an inanimate object. The repair kit includes a UV patch. The UV patch includes a fiberglass felt. The UV patch also includes a UV activated hardening material. The UV activated hardening material is impregnated within the fiberglass felt in an inactivated state and hardens when exposed to UV radiation. The UV patch further includes a UV blocking backing material disposed proximate to the fiberglass felt. The repair kit also includes a pouch, where the pouch is configured to block UV radiation. The repair kit further includes a pair of gloves and instructions. The repair kit additionally includes a surface preparation material configured to allow a user to finish the UV patch after hardening.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates an example of a UV patch;

FIG. 2 illustrates an example of a UV patch with a backing material disposed proximate to the UV patch; and

FIG. 3 illustrates an example of a repair kit.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

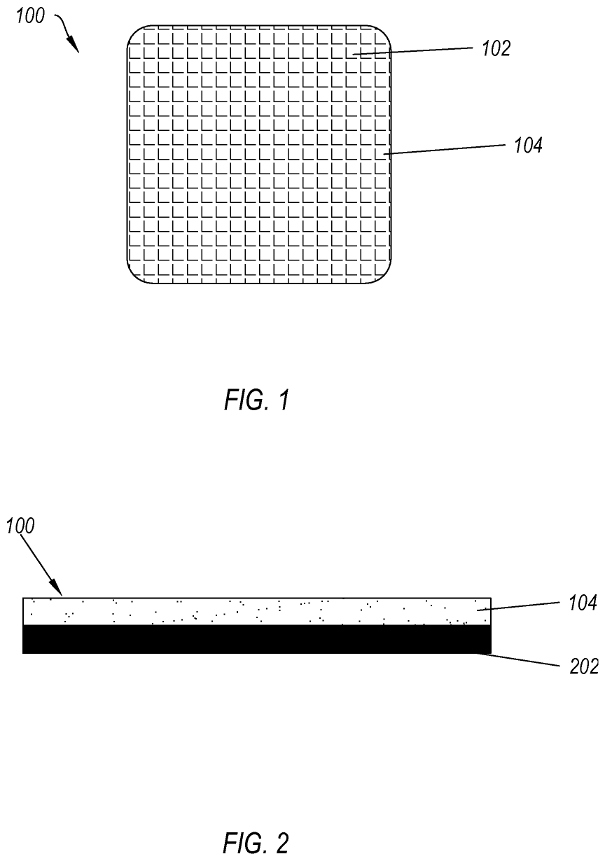

FIG. 1 illustrates an example of a UV patch 100. The UV patch 100 can be employed in a wide variety of applications. For example, the UV patch 100 may be used to repair, temporarily or permanently, broken items. E.g., if a hole has been created in an object or the object has been thinned or otherwise damaged, the UV patch 100 can be placed over the hole or weak spot. As the UV patch 100 hardens it strengthens the item. Additionally or alternatively, the UV patch 100 may be used to join two or more elements together, even if the elements were not previously broken apart from each other, may be used to strengthen an object or used for any other desired purpose.

In general, the UV patch 100 may be employed to affect repairs of broken items that may be rigid, or relatively flexible. As used herein, the term ‘repair’ is intended to be broadly construed and includes, but is not limited to: the joining of two pieces of an item that have partially or completely broken apart from each other and/or the covering of a hole, crack or fracture in an item or restore or straighten a bent or folded item.

General areas of application include industry, home and garden, sporting goods, recreation, landscaping, automotive, military and agriculture. For example, the UV patch 100 may be used in connection with a variety of different materials. Such materials include, but are not limited to, wood, metal, glass, plastic, rubber, composites, fiberglass, ceramic, concrete, and combinations of any of the foregoing. E.g., the UV patch 100 may be used to repair, temporarily or permanently, items such include bathtubs, wheelbarrows, drums or other containers, sinks, pipes, canoes or kayaks or sheets of materials, such as sheets of metal or fiberglass, etc.

FIG. 1 shows that the UV patch 100 can include fibrous material 102. For example, the fibrous material 102 may include non-woven fibers including felts and chop strand fabrics, woven fibers including twills plain weaves and roving weaves, knit fibers, or any other desired fibers and/or patterns. Felt is a textile that is produced by matting, condensing and pressing fibers together. Felt can vary in terms of fiber content, color, size, thickness, density and more factors depending on the use of the felt. Conversely, a chopped strand mat is made up of 1″-2″ long strands that are randomly oriented and which may be held together with a binder that acts like glue connecting the fibers. It comes in a variety of weights, typically between 0.75 oz to 3 oz per square foot. The fiber used in the fibrous material 102 can be selected for one or more desirable properties. Such properties can include fire-resistance, water-resistance, mold-resistance, fungus-resistance, heat-resistance, tear-resistance, to name a few examples.

Fiberglass: Fiberglass is extremely strong and inexpensive. It is easy to manufacture and there are many types of commercially available woven, non-woven and knit cloths. Fiberglass is brittle, it is very strong but when it breaks, it shatters and the splinters can be sharp and dangerous. Sanding of fibers can cause skin irritation. Fiberglass has low absorption properties (e.g., it would be difficult to clean up a pool of water with a fiberglass cloth). Any low viscosity material has to be forced into it under pressure and my not stay adhered will to the fibers even after saturation.

Carbon Fiber: Carbon fiber is much stronger than glass fiber. But it is also much more expensive (8-10 times more expensive) than fiberglass. Like fiberglass it is brittle so it is hard to break but when it does it shatters and the splinters can be skin irritants. It does not sand well but it absorbs material slightly better than fiberglass. Carbon fiber is more suitable for extreme applications like those used by the military or construction industry.

Aramids and Para-Aramid Synthetic Fibers: The most famous of these fibers is Kevlar (a para-aramid fiber with the molecular formula [—CO—C₆H₄—CO—NH—C₆H₄—NH—]ₙ) but there are other fibers such as Nomex, Technora and others. These fibers are stronger and less brittle than fiberglass but not as strong as carbon fiber. They are also more expensive than fiberglass (2-3 times) but still much less expensive than carbon fiber. These fabrics are less brittle than fiberglass or carbon fiber and so they result in softer and more flexible cloths. This produces a UV patch 100 that has extremely high impact strengths. Aramids and para-aramid fibers can be used alone, in combination with one another, or combined with fiberglass and/or carbon fiber or in combination with other fibers.

Basalt: Basalt is manufactured the same way as fiberglass. Rather than melting down and extruding glass Basalt fibers are extruded volcanic rock. Basalt is more expensive than fiberglass and has many of the same cons (it is brittle, cannot be creased, etc.). It is slightly stronger than fiberglass but its main strength when compared to fiberglass is that it is extremely heat and chemical resistant. For example, fibrous material 102 that includes basalt can be used in high temperature situations. For example, the UV patch that includes basalt can be used to repair a tail pipe on a car, or a surface that will be exposed to open flames.

Polyester, Nylon and other plastic fibers: These fibers are extremely strong and inexpensive. Unlike most of the above fibers they do not irritate the skin if you sand them or break them. They can take a lot of vibration and impact because they are more flexible where the fibers above are more brittle. These fibers can take more total load per weight than fiberglass but they start to deform at lower weights.

Natural Fibers: Natural fibers are a very broad category. These could be plant fibers like Hemp, Cotton or bamboo or animal fibers like Silk, wool, or even Spider Silk. Natural fibers tend to be expensive, and difficult to work with (because they are not uniformly manufactured). They can be just as strong as or even stronger than many of the synthetic fibers. The main advantage with natural fibers over all of the synthetic fibers above is that they are biodegradable. In other words, natural fibers may eventually degrade allowing the UV patch 100 to be removed easily or would naturally fall apart.

FIG. 1 also shows that UV patch 100 can include a UV activated hardening material 104. The UV activated hardening material 104 is impregnated within the fibrous material 102. The UV activated hardening material 104 can include any compound which is configured to harden and secure the fabric 102 in place. The UV activated hardening material 104 may be cured to harden into a set configuration. The cured UV activated hardening material 104 and the fibrous material 102 will then provide the properties of the UV patch 100. As used in the specification and the claims, the phrase “configured to” denotes an actual state of configuration that fundamentally ties recited elements to the physical characteristics of the recited structure. As a result, the phrase “configured to” reaches well beyond merely describing functional language or intended use since the phrase actively recites an actual state of configuration.

The UV activated hardening material 104 can include any desired material. For example, the UV activated hardening material 104 can include resin (a liquid that will set into a hard lacquer or enamel-like finish) or any other hardening material. The UV activated hardening material 104 can be approximately 60% of the UV patch 100 by weight (with the fibrous material 102 be approximately 40% of the UV patch 100 by weight). For example, the UV activated hardening material 104 can include a resin which includes, by weight, 35-65% urethane acrylate, 5-15% epoxy acrylate, 10-25% trimethylolpropane triacrylate, 2-13.3% fumed silica and 2-10% photoinitiator. As used in the specification and the claims, the term approximately shall mean that the value is within 10% of the stated value, unless otherwise specified.

A photoinitiator is any chemical compound that decomposes into free radicals when exposed to light. In particular, the photoinitiator begins a chemical process, when exposed to UV light, which initiates hardening of the UV activated hardening material 104. Ultraviolet (UV) light is electromagnetic radiation with a wavelength from 400 nm to 10 nm, shorter than that of visible light but longer than X-rays. UV radiation is present in sunlight, and is produced by electric arcs and specialized lights.

UV patch 100 shown in FIG. 1 can include an additive. For example, the additive can include plastic, rubber, sand, wood particles, sawdust, or any other desired additive. The additives may or may not be biodegradable. In addition, the additives can be substantially non-toxic, allowing them to be handled during application and to repair items where non-toxic resins would be desirable, for example in repairing items that will carry drinking water.

FIG. 2 illustrates an example of a UV patch 100 with a backing material 202 disposed proximate to the UV patch 100. The backing material 202 is releasably attached to the UV patch 100 by the adhesive properties of the UV activated hardening material 104 or by an adhesive layer. In particular, the backing material 202 can include paper or any other material suitable for protecting the UV activated hardening material on the UV patch 100 from drying or becoming activated before use. Additionally or alternatively, the backing material 202 can prevent UV radiation from reaching the UV patch 100. For example, the backing material 202 can include a UV blocking material.

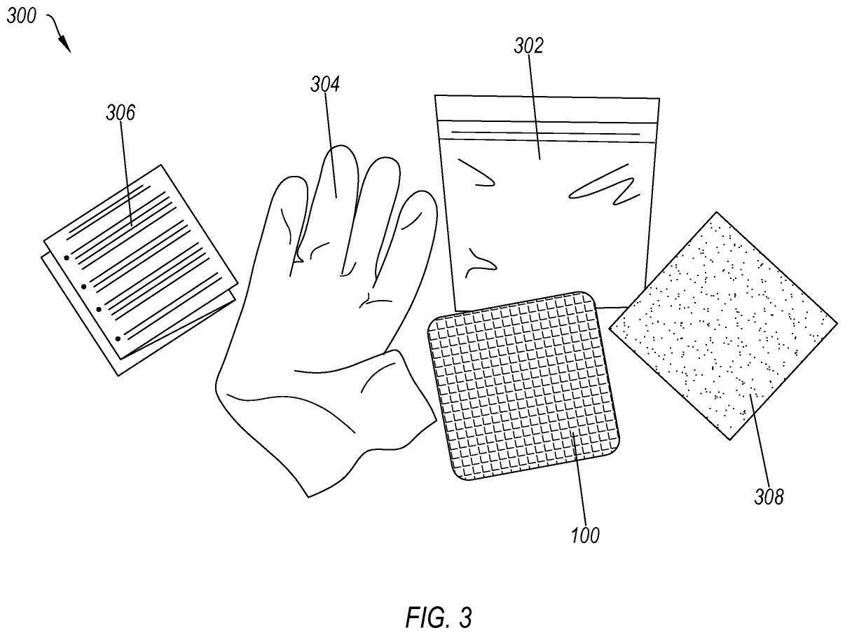

FIG. 3 illustrates an example of a repair kit 300. The repair kit 300 can include all of the material required for a user to repair or strengthen an object. In particular, the repair kit 300 can allow a user to purchase, in a single transaction, all required elements to perform a repair and/or strengthen an inanimate object.

FIG. 3 shows that the repair kit 300 can include UV patch 100. The UV patch 100 can include a fibrous material and a UV activated hardening material. Because most resins must be used quickly after activation, the amount of UV patch 100 in the repair kit 300 should be enough to complete a repair but no more or else there will be waste. Therefore, the UV patch 100 may be a few general sizes. For example, the repair kit can include UV patches 100 that are 3″×3″, 2″×8″, 5″×5″ or any other desired size.

FIG. 3 also shows that the repair kit 300 can include a pouch 302. Because the hardening material in the UV patch 100 may be activated by UV radiation, it should be stored in a pouch 302 which blocks UV radiation or sunlight will activate it. That also means that a user must use the entire product at one time. In other words, once he/she opens the pouch 302, he/she has a limited amount of time to apply the UV patch 100 before it hardens because of ambient UV radiation.

FIG. 3 further shows that the repair kit 300 can include gloves 304. The gloves 304 can allow the user to handle the UV patch 100 without getting the UV activated hardening material on his/her hands. Additionally or alternatively, the gloves 304 can prevent the user from contaminating the UV activated hardening material in the UV patch 100. The UV activated hardening material can include chemicals that may otherwise irritate the user's skin, which can be prevented by the gloves 304.

FIG. 3 additionally shows that the repair kit 300 can include instructions 306. The instructions 306 can include information about the UV patch 100 and how it can be best used to affect the desired repair. Additionally or alternatively, the instructions 306 can include information about where instructions, tips, repair examples, or other information can be found. Instructions 306 can include a website or other information that will tell a user where to find required information such as instructional videos.

FIG. 3 moreover shows that the repair kit 300 can include surface preparation materials 308. Surface preparation materials 308 can include sandpaper or other abrasive material for cleaning and roughing up the surface, a cleaning towel or agent, and or a bonding agent to increase the adhesive properties. Additionally or alternatively, surface preparation materials 308 can include paint or other materials configured to change the appearance of the hardened UV patch 100.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for repairing inanimate objects with a UV patch comprising the steps of:
providing a UV patch comprising
a fibrous material impregnated with a UV-activated hardening material, wherein
the UV-activated hardening material comprises:
5-15% epoxy acrylate by weight;
10-25% trimethylolpropane triacrylate by weight;
2-13.3% fumed silica by weight; and
a photoinitiator, wherein the photoinitiator includes a chemical compound that decomposes into free radicals when exposed to electromagnetic radiation with a wavelength from 400 nm to 10 nm;
applying the UV patch to an inanimate object in need of repair; and
exposing the applied UV patch to UV light to begin a chemical process through the decomposition of the free radicals in the photoinitiator to initiate hardening of the UV-activated hardening material.

2. The method of claim 1, wherein the fibrous material is approximately 40% of the UV patch by weight.

3. The method of claim 1, wherein the UV activated hardening material is approximately 60% of the UV patch by weight.

4. The method of claim 1, wherein the fibrous material includes a felt.

5. The method of claim 1, wherein the fibrous material includes a chop strand fabric.

6. The method of claim 1, wherein the fibrous material includes fiberglass.

7. The method of claim 1, wherein the fibrous material includes at least one of:
carbon fibers;
aramid fibers;
para-aramid fibers;
para-aramid fibers that have a [—CO—C6H4-CO—NH—C6H4-NH—] molecular group;
basalt fibers;
polyester;
nylon; or
natural fibers.

8. The method of claim 1, wherein the UV-activated hardening material includes an additive disposed in the UV-activated hardening material.

9. The method of claim 8, wherein the additive includes at least one of:
plastic;
rubber;
sand;
wood particles; or
sawdust.

10. The method of claim 1, wherein the UV-activated hardening material includes a resin.

11. A method for repairing inanimate objects with a UV patch comprising the steps of:
providing a UV patch comprising
a chopped strand mat impregnated with a UV-activated resin in an inactivated state, wherein the UV-activated resin comprises:
epoxy acrylate;
trimethylolpropane triacrylate; and
fumed silica;
a photoinitiator, wherein the photoinitiator includes a chemical compound that decomposes into free radicals when exposed to electromagnetic radiation with a wavelength from 400 nm to 10 nm; and
a UV-blocking backing material comprising paper and disposed proximate and releasably attached to the chopped strand mat;
applying the UV patch to an inanimate object in need of repair; and
exposing the applied UV patch to UV light to begin a chemical process through the decomposition of the free radicals in the photoinitiator to initiate hardening of the UV-activated resin.

12. The method of claim 11, wherein the UV activated resin includes 35-65% urethane acrylate by weight.

13. The method of claim 11, wherein the epoxy acrylate comprises 5-15% of the UV activated resin by weight.

14. The method of claim 11, wherein the trimethylolpropane triacrylate comprises 10-25% of the UV activated resin by weight.

15. The method of claim 11, wherein the fumed silica comprises 2-13.3% of the UV activated resin by weight.

16. The method of claim 11, wherein the photoinitiator comprises 2-10% of the UV activated resin by weight.
